(19) United States
(12) Patent Application Publication
(10) Pub. No.: US 2016/0189097 A1
(43) Pub. Date: Jun. 30, 2016

(54) ORDER MODIFICATION

(71) Applicant: EBAY INC., San Jose, CA (US)

(72) Inventors: Saji Hussain Padmaraagam, Chennai (IN); Badrinath Vengalathur Srinath, Chennai (IN); Sathish Vaidyanathan, Chennai (IN); Prabhakar Ramadass, Chennai (IN)

(21) Appl. No.: 14/582,845

(22) Filed: Dec. 24, 2014

(51) Int. Cl. G06Q 10/08; G06Q 30/06

(52) U.S. Cl. CPC G06Q 10/0835; G06Q 10/0833; G06Q 30/0635

(57) ABSTRACT

A system is provided that allows a user to make modification to an online order that the user previously made. In particular, when the system receives the user's instruction to modify an online purchase order, the system may determine or track the progress of the purchase order. Based on the progress of the purchase order, the system may implement modification to the purchase order accordingly. In an embodiment, the system may determine the cost of making such modification and may present the user with the fee or cost for making such modification. The system may allow the user to review the cost for making the modification and decide whether to proceed with the modification. For example, the user may decide not to proceed with the modification, because the cost or fee for making the modification exceeds the amount the user is willing to pay.

### BACKGROUND

1. Field of the Invention

The present invention generally relates to a system for order modification, and in particular, devices and methods for implementing order modification.

2. Related Art

With the popularity of electronic commerce, customers are more frequently making purchases online. Once an online purchase order is made, it is often difficult to make changes to the online purchase order, because the products may already have been packaged and shipped out from the merchant's facility. As such, a customer may need to make another purchase order if he/she wishes to purchase additional items. In the case when the customer wishes to cancel an online purchase order, the customer may have to wait to receive the products and then return the products by shipping them back to the merchant. This may cause inconvenience to customers. Thus, there is a need for an improved system for online order modification.

### BRIEF DESCRIPTION OF THE FIGURES

FIG. 1 is a block diagram of a networked system suitable for implementing online order modification according to an embodiment.

FIG. 2 is a diagram illustrating an online order and shipping process according to one embodiment.

FIG. 3 is a flow chart showing a process for online order modification in accordance with one embodiment.

FIG. 4 is a block diagram of a computer system suitable for implementing one or more components in FIG. 1 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

In an embodiment, a system is provided that allows a user to make modifications to an online (or offline) order that the user previously made. In particular, when the system receives the user's instruction to modify a purchase order, the system may determine or track the progress of the purchase order. Based on the progress of the purchase order, the system may implement one or more modifications to the purchase order accordingly.

In an embodiment, the system may determine the cost of making such modification(s) and may present the user with the fee or cost for making such modification(s). The system may allow the user to review the cost for making the modification(s) and decide whether to proceed with the modification(s). For example, the user may decide not to proceed with one or more of the modification(s), because the cost or fee for making the modification(s) exceeds the amount the user is willing to pay.

When the order modification is requested, the system may track the progress of the purchase order previously made by the user. There may be many different scenarios on the progress. First, the purchase order is still being prepared at the merchant's facility and has not been shipped out. In this first scenario, the preparation of the purchase order may be held at the merchant's facility. The cost for making changes may be determined based on the progress of the order preparation. For example, if the purchased items have been packaged, there may be cost for repackaging the items. The user may be presented with the cost of modification and may have the opportunity to decide whether the user wishes to proceed with the modification. If so, the order modification may be implemented at the merchant's facility.

In a second scenario, the order already has been shipped out from the merchant's facility and is in transit within the shipping network. The system may track and determine where the purchase order is within the shipping network or route. In an embodiment, the system may implement the shipment tracking process in coordination with a shipping service provider. The system may determine where the purchase order may be modified in transit, such as holding the purchase order at an in-transit facility within the shipping network. The system may determine the cost of modification and may present the cost or fee to the user. The user may decide whether to proceed with the modification. If so, the system may send instructions or request to the in-transit facility to make modifications accordingly.

In an embodiment, the order modification is for item addition in which an additional item or items are added to the online order. Depending on the progress of the order and shipping process, the system may hold the items of the original order at the merchant's facility or at an in-transit facility located between the merchant's facility and the customer's address. The system may instruct the merchant to ship out the additional items to be added to the original order. When the new items reach the location where the original order is being held, the original order may be combined with the additional items and the updated order with the additional items may be shipped together to the customer.

In an embodiment, the order modification is for deleting one or more items from the original order. Depending on the progress of the order and the shipping process, the system may hold the items of the original order at the merchant's facility or at an in-transit facility located between the merchant's facility and the customer's address. The system may instruct the personnel at the merchant's facility or the in-transit facility to remove the items to be deleted from the original order, repackage (if needed), and ship the remaining items to the customer.

In an embodiment, the order modification is for canceling the entire order. Depending on the progress of the order and the shipping process, the system may hold the items of the original order at the merchant's facility or at an in-transit facility located between the merchant's facility and the customer's address. The system may instruct the personnel to ship the order back to merchant and/or reshelf the items in the order at the warehouse. In an embodiment, the order modification is for a change of delivery schedule or a change of shipping address. The order may be relabeled for an updated shipping address and/or held for an updated delivery schedule.

Accordingly, the system may allow consumers to make changes to purchase orders while the online purchase order are being prepared or shipped to the consumers. In particular, the system may determine and present the cost for making order modifications to the consumers, such that the consumers may make decisions on whether to proceed with the modifications.

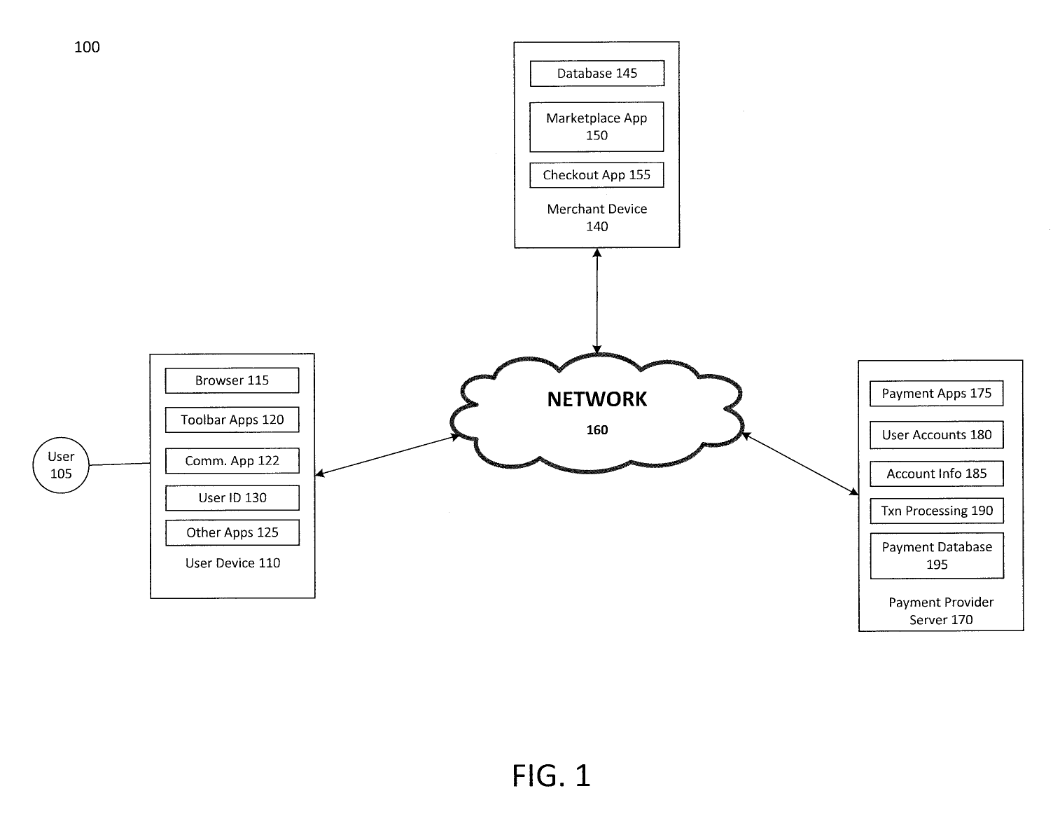

FIG. 1 is a block diagram of a networked system 100 suitable for implementing an online order modification process according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a merchant device 140, and a payment provider server 170 in communication over a network 160. Payment provider server 170 may be maintained by a payment service provider, such as PayPal, Inc. of San Jose, Calif. A user 105, such as a sender or consumer, utilizes user device 110 to perform a transaction using payment provider server 170. User 105 may utilize user device 110 to browse and shop at the merchant's online store and the payment provider server 170 may facilitate payments between the user 105 and the merchant for the online purchases made by the user 105.

The merchant device 140 or the payment provider server 170 may keep track of online purchase orders made at the merchant and may implement or coordinate modifications to the online purchase orders made with the merchant. In particular, the user 105 may utilize user device 110 to send requests for order modifications to the merchant device 140 or the payment provider server 170. The merchant device 140 or the payment provider server 170 may determine the progress of the online order and determine the cost for making modifications. If the user 105 wishes to proceed with the modifications, the merchant device 140 or the payment provider server 170 may coordinate to make the modifications to the online order.

User device 110, merchant server 140, and payment provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, user device 110 may be implemented as a personal computer (PC), a smart phone, wearable device, laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for setting up a shopping list and/or merchant sites for viewing and purchasing products and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications.

Applications 125 may also include email, texting, voice and IM applications that allow user 105 to send and receive emails, calls, and texts through network 160, as well as applications that enable the user to communicate, transfer information, make purchases, make payments, and otherwise modify purchase orders made. User device 110 includes one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100.

Merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as banks and retailers. For example, a payment may be a donation to charity or a deposit to a saving account. Merchant server 140 may include a database 145 identifying available products (including digital goods) and/or services (e.g., collectively referred to as items) which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser applications over network 160 in order to view various products, food items, or services identified in database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment service provider server 170 over network 160. For example, checkout application 155 may receive and process a payment confirmation from payment service provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like. Merchant server 140 also may include a reader or a scanner configured to read or scan payment codes from the user device 110. For example, the merchant server 140 may include an optical scanner at the POS of the merchant to scan payment codes displayed on user 105's user device 110 to process payment.

Payment provider server 170 may be maintained, for example, by an online payment service provider which may provide payment processing between user 105 and the operator of merchant server 140. In this regard, payment provider server 170 includes one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as banks or credit card companies. For example, account information 185 may include private financial information of users of devices such as account numbers, passwords, device identifiers, user names, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from user device 110 and/or merchant server 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary.

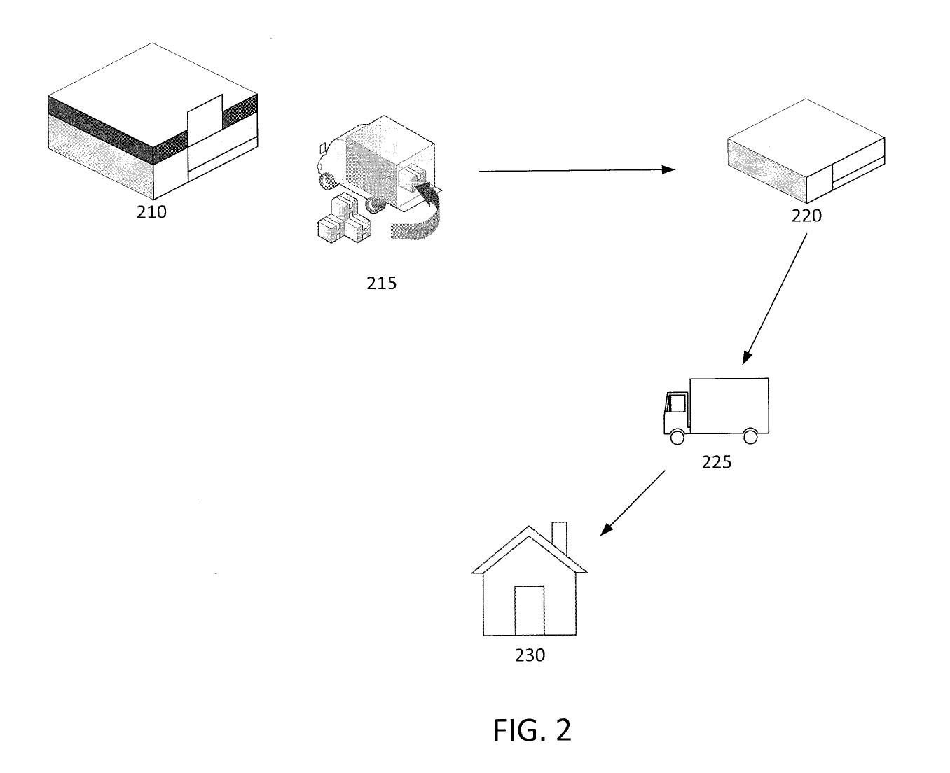

FIG. 2 is a diagram illustrating an online order and shipping process according to one embodiment. The merchant may operate a merchant facility 210 where products are stored and prepared for delivery to customers. When an online purchase order is received, the merchant may prepare and package the purchase order at the merchant facility 210. The purchase order may then be shipped out from the merchant facility 210. In an embodiment, the shipping process may be handled by a shipping service provider 215. The shipment may be routed through various channels and modes of transportation including ground trucking, air shipment, container ships, drones, and the like.

In some embodiments, the purchase order may be routed through a network of shipping centers and facilities including in-transit facility 220. The in-transit facility 220 may be a shipping hub where shipments from various senders are collected, streamlined, and organized, and routed to different destinations. The in-transit facility 220 may include an order modification department where purchase orders may be held, modified, repackaged, relabeled, and the like. The shipping route of the purchase order may have one or more in-transit facilities where the purchase order may be held, modified, relabeled, and/or repackaged.

The in-transit facility 220 may then route and ship the purchase order to the next or the final destination based on the shipping route of the purchase order. Eventually, the online order than may be delivered to the user's location 230 via a shipping vehicle 225, which may be part of the shipping service provider's operation. The merchant or the third-party shipping service provider may provide a tracking system for tracking the shipping progress of the order. For example, the order package may be affixed with a tracking label, such as a bar code, a QR code, or the like. The tracking label may be scanned by a scanner when the order package arrives and departs at various shipping facilities, shipping vehicles, and the like. As such, the shipping system of the merchant or the third-party shipping service provider may track the location and shipping progress of the order package based on where the tracking label was last scanned.

In an embodiment, a tracking device may be attached to the purchase order or the order package. The tracking device may emit a signal indicating the location of the purchase order. The signal from the tracking device may be captured or detected by various detection devices implemented in the shipping system. As such, the system may detect the location of the order package and determine the shipping progress of the purchase order.

The system may allow the user 105 to make modifications to the purchase order at various points or stages in the order preparation and shipping process. For example, the user 105 may make modifications to the purchase order when the purchase order still is at the merchant facility 210. In another example, the user 105 may make modifications to the purchase order when the purchase order is shipped from the merchant facility 210 and is in-transit within the shipping service provider's shipping network 215 or 220. In still another example, the user 105 may make modifications to the purchase order when the purchase order is on shipping vehicle 225 and is in-transit to the user's location 230. In an embodiment, the system may determine the cost of the modification based on the progress of the purchase order, the type of order modifications being made, the type of shipping route, and/or the availability of means for making modifications while the purchase order is en route.

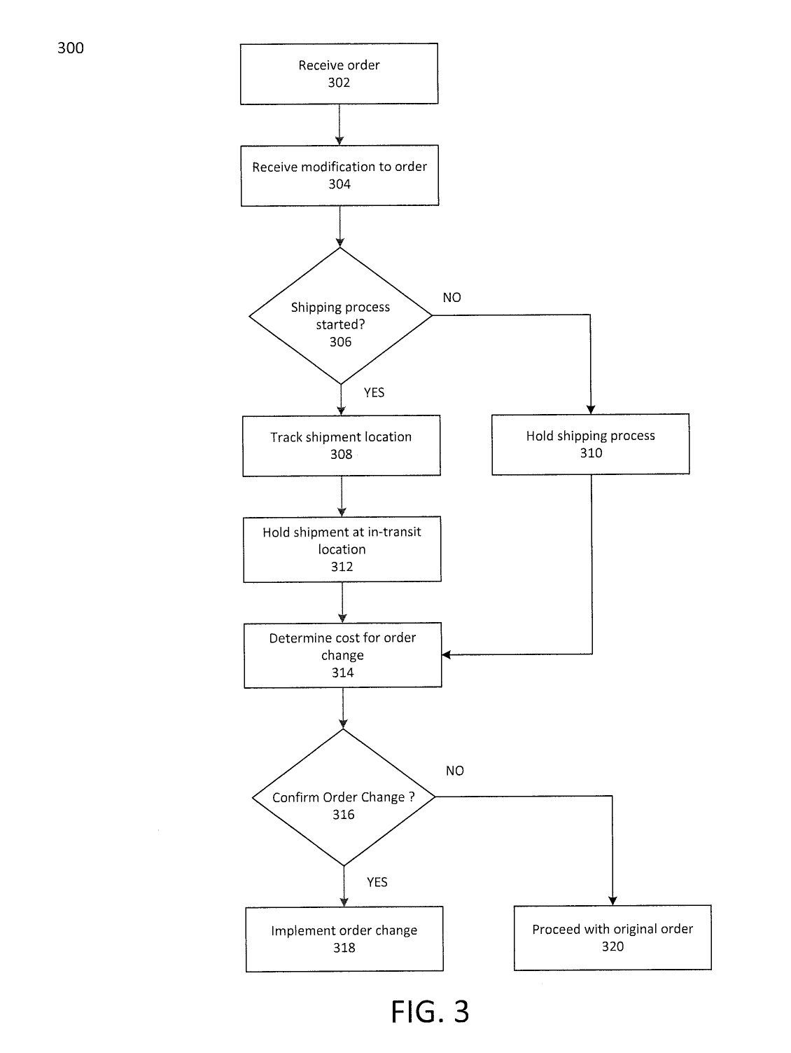

FIG. 3 is a flowchart illustrating a process for online order modification according to an embodiment. At step 302, the merchant device 140 or the payment provider server 170 may receive an online or offline purchase order from the user 105. The purchase order may be an order for products, services, or other items that may be purchased at the merchant's online or offline store. The purchase order may be assigned a unique identification number. The user 105 may enter the shipping address and method of shipping for the purchase order. For example, the user 105 may enter his/her home address and may select from different shipping methods, such as expedited or regular shipping.

The system may calculate the total cost for the purchase order including the cost of products or services, shipping and handling, taxes, or any other applicable fees. The payment service provider may process payment for the purchase order. After the user 105 confirms and pays for the order, the system may present or send the user 105 with an order confirmation. The system may instruct the merchant to begin to prepare the purchase order. For example, the merchant may begin to collect, package, and ship the items in the purchase order.

The system may also determine a shipping route based on the location(s) of the item(s) in the order (such as the location of a merchant's warehouse), the shipping location of the purchase order, the type of shipping methods selected, and the like. In an embodiment, the purchase order may be collected by the third-party shipping service provider and the third-party shipping service provider may determine the shipping route, based on the shipping network available. Thus, the purchase order may be prepared, packaged, and shipped out from the merchant or from the merchant's facility 210.

At step 304, the merchant device 140 or the payment provider server 170 may receive the user 105's request to modify the online purchase order. The modification may include one or more of addition, deletion, cancellation, change of delivery methods or schedule, change of shipping address, substitution, and the like. In response, the system may check the progress of the order. In step 306, the system may check to see if the order has been shipped from the merchant facility 210.

If the order has not been shipped, the system may instruct the merchant to hold the shipping process at the merchant facility 210 in step 310. Depending on what kind of modification is requested and whether the purchase order has been packaged, the system may determine the cost for making the requested modification at step 314. For example, if the purchase order has been packaged and ready for shipping and the modification is for deleting items from the purchase order, the system may include a repackaging or service fee to the modification cost, because the order package needs to be opened up to remove certain items and repackaged. Further, the removed items may need to be restocked and a restocking fee may apply. In another example, if the purchase order has not been packaged and the modification is for adding more items, the merchant may allow free modification to allow more purchases.

If the shipping process has started, the system may track the current location of the order in the shipment network at step 308. In an embodiment, the merchant or the payment service provider may coordinate with a shipping service provider to track the location or progress of the order in the shipment network. Each order or each shipment may have a unique ID, bar code, Quick Response (QR) code, and/or RFID tag. The unique code may be scanned when the order or the shipment arrives and/or departs from a shipping location within the network. As such, the location of the order or shipment may be determined based on where the order or shipment was last scanned. In an embodiment, the order package may be affixed with a tracking device by which the location of the order package may be detected by the shipping network.

At step 312, the system may hold the order shipment at an in-transit location. In particular, based on the shipping route of the purchase order, the system may find the next in-transit shipping location from the order's current location and may instruct that the order be held at the next in-transit shipping location, such as in-transit shipping location 220. In an embodiment, the system may find an in-transit shipping location that is closest to the order package's current location and the order package may be shipped to the closest in-transit location to process the modification.

In an embodiment, the system may find a next in-transit shipping location that is capable of handling the type of modification requested. For example, if the requested modification is for deleting or adding items to the purchase order, the system may find a next in-transit shipping location that has a facility for holding and repackaging the purchase order. In another example, if the requested modification is for canceling the entire order or for changing shipping address, the system may find a next in-transit shipping location that has a facility for returning the shipping order or for relabeling and updating the shipping destination.

At step 314, the system may determine the cost of the order modification based on the progress of the order and the modification to be made to the order. For example, if the modification is addition of items to the order, the system may estimate how much it costs to hold the order at the merchant facility 210 or at the in-transit facility 220, the cost for shipping the order to the in-transit facility 220, the cost for shipping the additional items from the merchant to the in-transit facility 220, the cost for repackaging the order with the additional items, and other fees or costs, and the cost for shipping the updated order from the in-transit facility 220 to the final destination designated by the customer.

If the modification is for canceling the order, the system may estimate how much it cost to return the order from the order's current location back to the merchant facility 210. If the modification is for deleting items from the order, the system may estimate how much it costs to ship the order to the in-transit facility 220, how much it costs to remove items and repackage the order, how much it costs to ship the removed items back to the merchant facility 210, and how much it costs to ship the updated order from the in-transit facility 220 to the final destination designated by the customer.

The additional cost for making the modification to the order may be presented to the user 105 at user device 110. The user 105 may then decide whether to proceed with the modification based on the cost and/or other factors, such as a shipping or arrival delay. For example, the user 105 may compare the cost for making the modification and the cost for making a new order or the cost for returning the order. The user 105 also may determine whether to proceed with the modification based on the user 105's personal needs and requirements.

In an embodiment, the system may estimate the shipping delay that may be caused by the modification process. In particular, the system may estimate how long it takes for the package order to reach the in-transit facility and based on the type of modification, how long the package order will be held at the in-transit facility waiting to be modified. For example, if the modification is for adding one or more items to the order, the system may estimate how long it takes for the additional items to be prepared and shipped out from the merchant, how long it takes for the additional items to reach the in-transit facility where the original order is held, how long it takes to add and repackage the order, and how long it takes for the updated order to be shipped to the customer. If the modification is for deleting one or more items from the order, the system may estimate how long it takes for the order to be modified and repackaged at the in-transit facility. If the modification is for canceling the entire order, the system may estimate how long it takes for the package to be shipped back and returned to the merchant and when the customer may be refunded.

In an embodiment, the system may present the user with options to compensate for the delay due to the modification process. In particular, the system may determine and present to the user other shipping methods that may speed up the shipping process to compensate for the modification delay, such that the customer may receive the modified order at about the same time as the original order which is not modified. For example, the modification may cause delay of three days. The system may suggest that the user should also change the shipping method to air shipping and the updated package will be delivered to the customer at approximately the same time as the original order. Thus, the user may have options to receive the order delivery at approximately the same time even if the user decides to proceed with the modification to the order.

If the user 105 decides not to proceed with the order change at step 316, the system may continue with the original order at step 320. As such, the user 105 may receive the original order without modifications. If the user 105 decides to proceed with the modification at step 316, the system may confirm the order change with the user 105 and may proceed to implement order change at step 318. In an embodiment, the system may process payment for the modification fee.

If the modification is for adding items to the order, the system may hold the original order at the in-transit facility 220. The system may first check the availability of the items at the merchant. If the items are available, the system may instruct the merchant to prepare and ship out the additional items to the in-transit facility 220. The additional items may then be added to the original order at the in-transit facility 220. The modified order then may be shipped to the user location 230. If the items are not available, the system may estimate when the items will be in stock at the merchant. A ship out date or time may then be estimated for the one or more items to be shipped to the in-transit facility 220.

If the modification is for deleting items to the order, the system may remove the items to be deleted at the in-transit facility 220 and may repackage the modified order and ship the modified order to the user location 230. The deleted items also may be packaged and shipped back to the merchant. After the merchant has confirmed that the deleted items are received, the system may process refund to the user 105 for the deleted items. If the modification is for canceling the entire order, the system may re-label the order for shipping back to the merchant facility 210. If the modification is for change of shipping schedule, the order may be held at the in-transit facility 220 for a period of time in accordance with the updated shipping schedule. In another example, the order may be labeled for a different method of shipping, such as air shipping to speed up the shipping schedule or ground shipping to slow the shipping schedule. In still another example, the shipping service provider may be instructed to hold onto the order and deliver the order to the customer at a date designated by the customer. As such, the customer may choose a day or time when the customer will be home to receive the shipping.

In an embodiment, the items to be added may be located at different locations of the merchant, such as at different warehouses of the merchant. The system may determine a location for consolidating the order to minimize shipping time and cost. In an embodiment, the system may estimate and present the cost for adding each item to the user. For example, an item that is located farther from the current location of the purchase order may cost more to add compared to another item that is located closer to the current location of the purchase order. As such, the user 105 may choose which items the user 105 wishes to add in view of the cost of each item.

Accordingly, by implementing the above system and process, users may change purchase orders even after the order has been made, processed, or shipped out. Further, the system may determine and present the user with the cost of making changes to the order, and/or the estimated delay that may be caused by the modification, such that the user may decide whether to proceed with order modification. Therefore, the system may provide flexibility and convenience to the user when purchasing products.

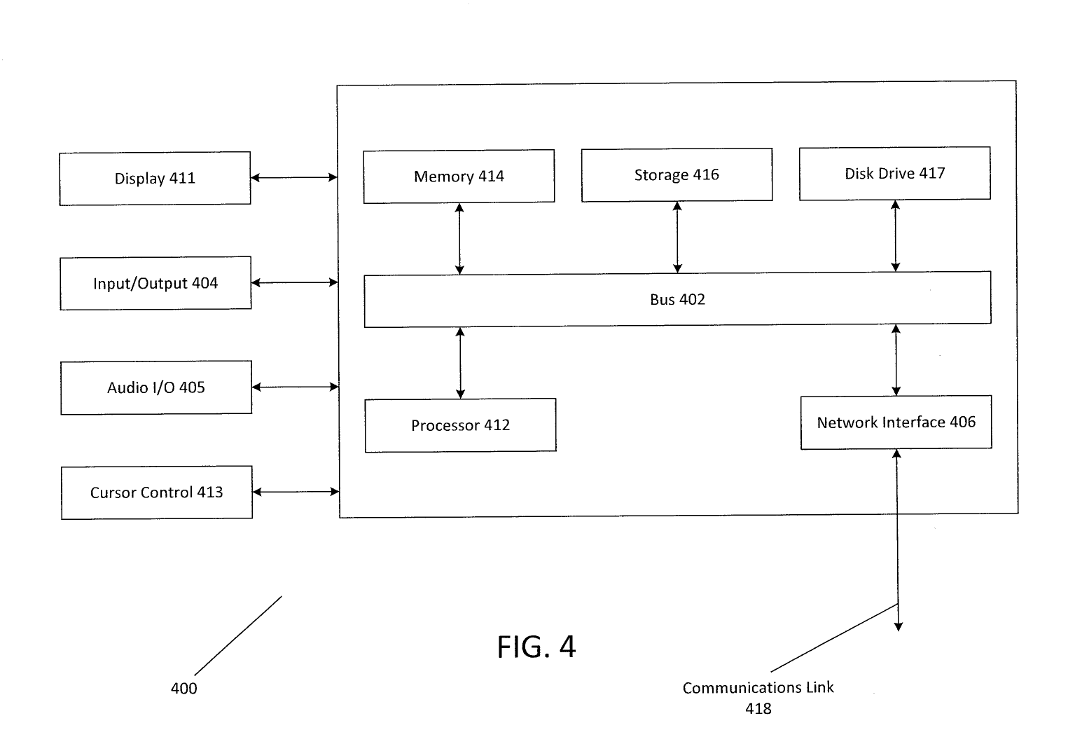

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 160. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a memory storing a purchase order made by a user at a merchant; and
one or more processors in communication with the memory and adapted to:
receive a request from the user for making a modification to the purchase order;
determine a location of the purchase order along a shipping route of the purchase order;
determine an in-transit facility based on the location of the purchase order for processing the purchase order; and
communicate an instruction to modify the purchase order at the in-transit facility.

2. The system of claim 1, wherein the in-transit facility is a next in-transit facility along the shipping route of the purchase order.

3. The system of claim 1, wherein the in-transit facility is a closest in-transit facility to the location of the purchase order.

4. The system of claim 1, wherein the one or more processors are further adapted to:
determine a cost for making the modification to the purchase order;
present the cost for making the modification to the user; and
receive an instruction from the user on whether to proceed with the modification to the purchase order based on the cost.

5. The system of claim 4, wherein the modification is for adding one or more additional items to the purchase order; and wherein the cost for making the modification includes one or more of a cost for shipping the purchase order to the in-transit facility, a cost for holding the purchase order at the in-transit facility, a cost for shipping the one or more additional items from the merchant to the in-transit facility, and a cost for repackaging the purchase order to include the one or more additional items.

6. The system of claim 4, wherein the modification is for deleting one or more items from the purchase order; and wherein the cost for making the modification includes one or more of a cost for shipping the purchase order to the in-transit facility, a cost for holding the purchase order at the in-transit facility, a cost for removing the one or more items and repackaging the order, and a cost for shipping the one or more items back to the merchant.

7. The system of claim 1, wherein the one or more processors are further adapted to:
estimate a delivery delay for the purchase order caused by the modification;
present the estimated delivery delay caused by the modification; and
receive an instruction from the user on whether to proceed with the modification to the purchase order based on the estimated delivery delay.

8. The system of claim 7, wherein the one or more processors are further adapted to:
determine an alternate shipping method based on the estimated delivery delay, wherein the alternate shipping method is a faster shipping method compensates the estimated delivery delay; and
present the alternate shipping method to the user.

9. The system of claim 4, wherein the one or more processors are further adapted to process a payment from the user for the cost for making the modification.

10. A method comprising:
receiving, by one or more processors, an indication that a purchase order has been made by a user;
receiving, by the one or more processors, a request from the user for making a modification to the purchase order;
determining, by the one or more processors, a location of the purchaser order along a shipping route of the purchase order;
determining, by the one or more processors, an in-transit facility based on the location of the purchase order for processing the purchase order; and
communicating, by the one or more processors, an instruction to modify the purchase order at the in-transit facility.

11. The method of claim 10 further comprising:
determining a cost for making the modification; and
presenting the cost for making the modification to the user.

12. The method of claim 10 further comprising:
determining a shipping delay caused by the modification; and
presenting the shipping delay caused by the modification to the user.

13. The method of claim 12, further comprising:
determining an alternate shipping method for expediting delivery of the purchase order to compensate the shipping delay; and
presenting the alternate shipping method to the user.

14. The method of claim 13, further comprising:
determining a cost for the alternate shipping method; and
presenting the cost for the alternate shipping method to the user.

15. The method of claim 10, wherein the in-transit facility comprises a facility equipped to process a type of the modification requested by the user.

16. The method of claim 10, wherein the modification is for adding one or more additional items to the purchase order and the method further comprises communicating, by the one or more processors, instructions for:
processing the purchase order at the in-transit facility;
preparing and shipping the one or more additional items from the merchant to the in-transit facility;
repackaging the purchase order with the one or more additional items; and
shipping the purchase order from the in-transit facility to a destination designated by the user.

17. The method of claim 10, wherein the modification is for deleting one or more items from the purchase order and the method further comprises communicating, by the one or more processors, instructions for:
processing the purchase order at the in-transit facility;
removing the one or more items from the purchase order and repackaging the purchase order;
preparing and shipping the removed one or more items from the in-transit facility back to the merchant;
repackaging the purchase order without the one or more items; and
shipping the purchase order from the in-transit facility to a destination designated by the user.

18. The method of claim 10, wherein the modification is for canceling the purchase order and the method further comprises communicating, by the one or more processors, instructions for:
processing the purchase order at the in-transit facility; and
re-label the purchase order and shipping the purchase order from the in-transit facility back to the merchant.

19. The method of claim 10, wherein the modification is for expediting a delivery schedule of the purchase order and the method further comprises communicating, by the one or more processors, instructions for:
processing the purchase order at the in-transit facility;
determining an alternate shipping method for expediting the delivery schedule; and
shipping the purchase order by the alternate shipping method from the in-transit facility to a destination designated by the user.

20. The method of claim 10, wherein the modification is for delaying a delivery schedule of the purchase order and the method further comprises communicating, by the one or more processors, instructions for:
processing the purchase order at the in-transit facility for a period of time based on a delay designated by the user; and
shipping the purchase order after the period of time from the in-transit facility to a destination designated by the user.
